(19) United States
(12) Patent Application Publication
(10) Pub. No.: US 2021/0098157 A1
(43) Pub. Date: Apr. 1, 2021

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: JIAN-GUO CAI, Kunshan (CN); JUAN ZHENG, Kunshan (CN); LU-YU CHANG, New Taipei (TW)

(21) Appl. No.: 17/033,602

(22) Filed: Sep. 25, 2020

(30) Foreign Application Priority Data
Sep. 30, 2019 (CN) 201910938154.8

(51) Int. Cl. H01B 11/18; H01B 3/44; H01B 1/02

(52) U.S. Cl. CPC H01B 11/1895; H01B 1/02; H01B 3/441; H01B 11/1808

(57) ABSTRACT

A cable includes: a pair of core wires; an insulating layer covering the pair of core wires; a shielding layer covering the insulating layer; and an outer insulating layer covering the shielding layer; wherein the shielding layer is a double-layer metal foil.

### BACKGROUND OF THE INVENTION

### 1. Field of the Invention

The present invention relates generally to a cable, and more particularly to a cable used to transmit high frequency signals.

### 2. Description of Related Arts

With the development and popularization of electronic technology products, signal cables are widely used in household appliances, instrumentation, automation equipment, data centers, servers, switches, cloud computing and 5G as a tool for signal transmission. However, in the signal transmission process, the cable is very susceptible to interference from external electromagnetic signals, so it is often necessary to use a shielding structure to eliminate or reduce the interference of the external electromagnetic field, and to prevent the leakage of the transmission signal.

Therefore, it is necessary to provide an improved cable with strong anti-interference performance, stable signal transmission, reliability and simple manufacturing.

### SUMMARY OF THE INVENTION

A main object of the present invention is to provide a cable, which has good shielding effect and stable signal transmission capability.

To achieve the above-mentioned object, a cable comprises: a pair of core wires; an insulating layer covering the pair of core wires; a shielding layer covering the insulating layer; and an outer insulating layer covering the shielding layer; wherein the shielding layer is a double-layer metal foil.

Compared to the prior art, the present invention has the advantage that the double-layer copper foil as shielding layer improves the shielding effect of high-speed signal cables and ensures the reliability of signal transmission, at the same time, the cable of the present invention has the ability to transmit high-speed data signals with a frequency greater than 40 GHz.

### BRIEF DESCRIPTION OF THE DRAWING

FIG. 1 is a cross-section view of the first embodiment of the cable of the present invention; and

FIG. 2 is a cross-section view of the second embodiment of the cable of the present invention.

### DETAILED DESCRIPTION OF THE PREFERRED EMBODIMENT

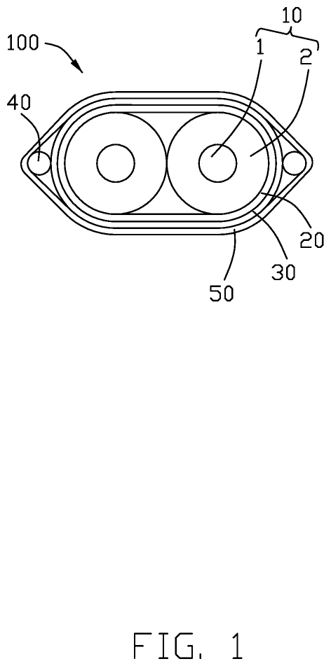

Referring to FIG. 1, which is the first embodiment of a cable 100 of the present invention. The cable 100 includes two core wires 10, an (intermediate) insulating layer 20, a shielding layer 30, a ground wire 40 and an outer insulating layer 50 in order from the inside to the outside. The insulating layer 20 covers the two core wires 10, the shielding layer 30 covers the insulating layer 20, and the outer insulating layer 50 covers the shielding layer 30. The ground wire 40 is located between the shielding layer 30 and the outer insulating layer 50.

In this embodiment, the two core wires 10 are contact with each other and extend in the longitudinal direction. Each core wire 10 includes an inner conductor 1 and an inner/core insulating layer 2 covering the inner conductor 1, and the inner conductor 1 is used for transmitting high-speed signal. The inner insulating layer 2 of each core wire 10 is extruded and molded to cover the inner conductor 1. The inner conductor 1 may be one of a copper inner conductor, a silver-plated copper inner conductor, and a tin-plated copper inner conductor. The inner insulating layer can be one of PP (polypropylene), PE (polyethylene), FEP (Fluorinated Ethylene-propylene), foamed PP, foamed PE, and foamed FEP. The inner insulating layers 2 of the two core wires 10 are touched to each other. The insulating layer 20 can be any one of PP, PE, PTFE (polytetrafluoroethylene) and E-PTFE (expanded polytetrafluoroethylene). The insulating layer 20 is wrapped around the two core wires 10 in a longitudinal coating manner or in a spiral winding manner. There are two ground wires 40, The two ground wires 40 are respectively located on the left and right side of the shielding layer 30. Roughly set on the extension line passing through the center of the two inner conductors 1. The shielding layer 30 is a double-layer metal foil, which includes any one of double-layer aluminum foil (AL/PET/AL) and double-layer copper foil (Cu/PET/Cu). The double-layer metal foil includes a PET (polyethylene terephthalate) layer and two metal layers respectively calendered on each side of the PET layer. It can also be based on PET and spray a metal layer on both sides of the PET layer. In this way, the double-layer metal foil is composed of metal layer, PET layer, and metal layer from one side to the other. The double-layer metal foil as shielding layer not only increases the thickness of the shielding layer 30, but also makes the shielding layer have a certain degree of ductility and is not easy to break. At the same time, there are metal layers on both sides of PET to increase the shielding effect. The double-layer metal foil is wrapped on the outside of the insulating layer 20 in a longitudinal wrapping manner or in a spiral winding manner. The outer insulating layer 50 can be set as one layer or multiple layers, which can be a tape made of PET. The outer insulating layer 50 is wrapped around the shielding layer 30 in a spiral winding manner.

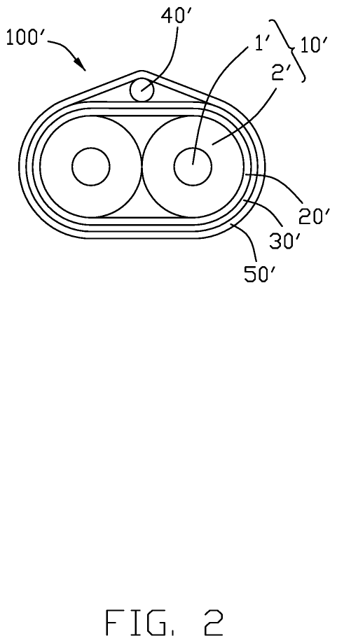

Please refer to FIG. 2, which is the second embodiment of the cable 100′ of the present invention. The cable 100′ comprises two core wires 10′, an insulating layer 20′ covering the two core wires 10′, a shielding layer 30′ covering the insulating layer 20′, an outer insulating layer 50′ covering the shielding layer 30′ and a ground wire 40′. Compared with the first embodiment, there is only one ground wire 40′ in this embodiment, which is arranged in the middle of the upper side of the shielding layer 30′ and on the extension line perpendicular to the midpoint of the connecting line of the two inner conductors 1′. The other composition and structure are the same as the first embodiment.

In the present invention, double-layer metal foil is used as the shielding layer, which improves the shielding effect. At the same time, the cable of the present invention has a high-speed data transmission capability with a signal frequency greater than 40 GHz. provides more options for improving the high frequency characteristics of cables. Adapt to the current high-speed development of high-speed cables.

The above are only some of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a pair of core wires;
an insulating layer covering the pair of core wires;
a shielding layer covering the insulating layer; and
an outer insulating layer covering the shielding layer; wherein
the shielding layer is a double-layer metal foil.

2. The cable as claimed in claim 1, wherein the double-layer metal foil includes at least one of a double-layer aluminum foil and a double-layer copper foil.

3. The cable as claimed in claim 1, wherein the double-layer metal foil includes a PET layer and two metal layers are respectively calendered on each side of the PET layer.

4. The cable as claimed in claim 1, wherein each of the core wire includes an inner conductor and an inner insulating layer covering the inner conductor by extrusion molding.

5. The cable as claimed in claim 4, wherein the inner conductor is selected from the group including copper inner conductors, silver-plated copper inner conductors, and tin-plated copper inner conductors.

6. The cable as claimed in claim 4, wherein the inner insulating layer is selected from the group including PE, PP, FEP, foamed PE, foamed PP, and foamed FEP.

7. The cable as claimed in claim 1, further including at least one ground wire arranged between the shielding layer and the outer insulating layer.

8. The cable as claimed in claim 1, wherein the insulating layer is selected from the group including PP, PE, PTFE, and E-PTFE.

9. The cable as claimed in claim 1, wherein the insulating layer covers the pair of core wires in a spiral winding manner.

10. The cable as claimed in claim 1, wherein the shielding layer covers the insulating layer in a spiral winding manner or a longitudinal coating manner.

11. A cable comprising:
a pair of core wires;
a shielding layer surrounding the insulating layer; and
an outer insulating layer covering the shielding layer; wherein
the shielding layer includes a PET layer and two metal layers are respectively calendered on each side of the PET layer.

12. The cable as claimed in claim 11, further including at least one ground wire sandwiched between the shielding layer and the outer insulating layer.

13. The cable as claimed in claim 12, further including an intermediate insulating layer sandwiched between the pair of core wires and the shielding layer.

14. The cable as claimed in claim 13, wherein each core wire includes an inner conductor and an inner insulating layer surrounding the inner conductor.
